(19) United States
(12) Patent Application Publication
(10) Pub. No.: US 2022/0364331 A1
(43) Pub. Date: Nov. 17, 2022

(54) SYSTEM AND METHOD FOR VEHICLE FLOW SYNCHRONIZATION WITH RESPECT TO A WORK MACHINE IN A MATERIAL LOADING CYCLE

(71) Applicant: Deere & Company, Moline, IL (US)

(72) Inventors: Cory M. Ouellette, Moline, IL (US); Francois Stander, Dubuque, IA (US); Jonathan Spendlove, Bettendorf, IA (US)

(21) Appl. No.: 17/383,626

(22) Filed: Jul. 23, 2021

Related U.S. Application Data
(60) Provisional application No. 63/187,806, filed on May 12, 2021.

(51) Int. Cl. E02F 9/26; B60K 35/00; G06Q 50/28; G06Q 10/06; G07C 5/00; G07C 5/08

(52) U.S. Cl. CPC E02F 9/26; B60K 35/00; G06Q 50/28; G06Q 10/06313; G07C 5/008; G07C 5/0825; G06Q 10/06312; E02F 3/32

(57) ABSTRACT

A system and method are provided for flow synchronization between various transport vehicles (e.g. dump trucks) and a work machine (e.g. excavator) in a material loading cycle. The work machine and each transport vehicle are configured to communicate with each other via a machine-to-machine communications network. A controller determines initiation of a loading cycle associated with the work machine and a first transport vehicle, and detects certain parameters corresponding to a duration of the loading cycle (e.g. weight of payload, volume of truck bin, historical cycle data). A remaining time in the loading cycle duration is accordingly estimated, and an output signal corresponding to the estimated remaining time is generated to at least a next transport vehicle in a loading sequence. The system and method facilitate even spacing of transport vehicles, consistent travel speeds, and optimization of a number of loading vehicles required to coordinate with a given work machine.

### FIELD OF THE DISCLOSURE

The present disclosure relates generally to work machines, and more particularly to systems and methods for synchronizing workflow of a plurality of transport vehicles with respect to such work machines in a material loading work cycle.

### BACKGROUND

Work machines as discussed herein may particularly refer to tracked excavator machines for illustrative purposes, but may also for example include wheeled or compact track loaders, forestry machines, and other equipment which modify the terrain or equivalent working environment in some way, and further are responsible for loading material from the proximate terrain into transport vehicles for delivery to a separate offloading site. Tracked or wheeled ground engaging units support an undercarriage from the ground surface, and the undercarriage may typically further support one or more work attachments (also or otherwise referred to as work implements) which are used to dig or otherwise extract material from the terrain and to selectively discharge the material into a loading area associated with the transport vehicles, such as for example the container of a dump truck.

As may be appreciated by one of skill in the art, there is a conventional lack of communication and synchronization between transport vehicles (e.g., dump trucks) in the load-dump cycle. An individual truck traveling without information regarding the preceding trucks in the cycle may frequently rush to the loading site but be obliged to stop and idle for a period of time while awaiting the loading of other trucks by the work machine (e.g., excavator).

This “rush and wait” cycle may result in inefficiencies and other undesirable issues with respect to the trucks, including for example fuel expenditures and unnecessary wear and tear to the drivetrain.

Another relevant example of inefficiencies in a work cycle may include where a crawler dozer or equivalent work machine is used to push scraper equipment. In many instances, a further (e.g., second) scraper may arrive before the previous (e.g., first) scraper is finished with the cut or otherwise before the crawler is ready. In these instances, the scraper might attempt to self-load, which generally results in relatively small loads and a less efficient cut.

### BRIEF SUMMARY

The current disclosure provides an enhancement to conventional systems, at least in part by introducing a novel system and method for synchronizing and preferably optimizing the workflow of trucks in a typical work cycle, for example in certain embodiments using machine-to-machine communications and driver interface tools for selective manual or automatic implementation of certain operations.

In one embodiment, a computer-implemented method is provided for flow synchronization between a plurality of transport vehicles and a work machine in a material loading cycle. The work machine may comprise a material loading implement, such as for example a boom assembly with a bucket. The plurality of transport vehicles may each comprise a loading area, such as for example a dump truck bin, and each of the transport vehicles may be operable for communication with each other via a communications network. A loading cycle is initiated in association with the work machine and a first transport vehicle of the plurality of transport vehicles, wherein one or more parameters are detected corresponding to a duration of the loading cycle including the first transport vehicle. Based at least in part thereon, a remaining time is estimated in the duration of the loading cycle including the first transport vehicle. An output signal may further be generated corresponding to the estimated remaining time to at least a second transport vehicle of the plurality of transport vehicles.

In one exemplary aspect in accordance with the above-referenced embodiment, the work machine may also be operable for communication with each of the plurality of transport vehicles.

In one exemplary aspect in accordance with the above-referenced embodiment, a target speed may be determined for the second transport vehicle based on at least the estimated remaining time and one or more parameters associated with a route between the second transport vehicle and the work machine.

A speed of the second transport vehicle may further be automatically controlled corresponding to the target speed.

In addition, or in the alternative, a display may be generated via a user interface associated with the second transport vehicle, the display comprising one or more of the determined travel speed, the estimated remaining time, and the one or more parameters associated with the route between the second transport vehicle and the work machine.

Alerts may for example be generated via the user interface corresponding to a detected actual travel speed being outside of a predetermined tolerance with respect to the target speed.

In another exemplary aspect in accordance with the above-referenced embodiment, for each of the plurality of transport vehicles other than the first transport vehicle, further estimations may be made of a remaining time in the duration of the loading cycle including the first transport vehicle and a duration of a loading cycle for each other one of the plurality of transport vehicles between the respective transport vehicle and the work machine. An output signal may be generated corresponding to the estimated remaining time to a subsequent transport vehicle in a sequence of the plurality of transport vehicles.

In another exemplary aspect in accordance with the above-referenced embodiment, a minimum duration may be determined of a work cycle comprising the loading cycle and a dumping cycle for at least one of the plurality of transport vehicles, and a minimum and/or maximum number of transport vehicles to optimize the work cycle based thereon may further be determined.

In another exemplary aspect in accordance with the above-referenced embodiment, an available number of transport vehicles may be determined along with a minimum duration of a work cycle comprising the loading cycle and a dumping cycle for at least one of the plurality of transport vehicles, and operation of the work machine may be dynamically adjusted based thereon to optimize performance. For example, a loading cycle associated with the work machine may desirably be lengthened in some embodiments to avoid a condition where a first transport vehicle is rapidly loaded but the work machine must idle for a period of time while waiting for the next transport vehicle.

In another exemplary aspect in accordance with the above-referenced embodiment, the detected one or more parameters corresponding to a duration of the loading cycle including the first transport vehicle comprises a weighed payload of material at the transport vehicle.

In another exemplary aspect in accordance with the above-referenced embodiment, the detected one or more parameters corresponding to a duration of the loading cycle including the first transport vehicle comprises an estimated volume of the loading area of the first transport vehicle, and the volume may be estimated via a scanned image of the loading area via an image data source associated with the work machine.

In another exemplary aspect in accordance with the above-referenced embodiment, the detected one or more parameters corresponding to a duration of the loading cycle including the first transport vehicle may comprise an estimated volume of the loading area of the first transport vehicle, wherein the volume is estimated via an identifier wirelessly read out from the first transport vehicle when in proximity with the work machine, and from information retrievably stored in associated with the identifier.

In another exemplary aspect in accordance with the above-referenced embodiment, the detected one or more parameters corresponding to a duration of the loading cycle including the first transport vehicle may comprise one or more previous load times retrieved from data storage. For example, the one or more previous load times may be associated with the first transport vehicle, and/or the one or more previous load times may be selected from data storage based at least in part on one or more characteristics of the first transport vehicle.

In another embodiment as disclosed herein, a work machine is configured for flow synchronization with a plurality of transport vehicles in a material loading cycle, wherein the plurality of transport vehicles each comprise a loading area. The work machine includes a main frame supported by a plurality of ground engaging units, at least one material loading implement supported from the main frame, a communications unit configured for communication with each of the plurality of transport vehicles via a wireless communications network, and a controller. The controller is configured, alone or in association with one or more of a payload measuring unit, a user interface, an imaging data source, a wireless reading unit, or the like, for directing the performance of operations according to the above-referenced method embodiment and optionally any of the associated exemplary aspects.

In another embodiment as disclosed herein, a system is provided for flow synchronization between a plurality of transport vehicles and a work machine in a material loading cycle, wherein the work machine comprises a material loading implement, and wherein the plurality of transport vehicles each comprise a loading area. For each of the work machine and the plurality of transport vehicles, a respective communications unit is operable for communication with each other of the work machine and the plurality of transport vehicles via a wireless communications network. A controller may be associated with the work machine and configured, alone or in association with one or more of a payload measuring unit, a user interface, an imaging data source, a wireless reading unit, or the like, for directing the performance of operations according to the above-referenced method embodiment and optionally any of the associated exemplary aspects.

Numerous objects, features and advantages of the embodiments set forth herein will be readily apparent to those skilled in the art upon reading of the following disclosure when taken in conjunction with the accompanying drawings.

### BRIEF DESCRIPTION OF THE DRAWINGS

FIG. 1 is a side view of an exemplary embodiment of a work machine in a loading position relative to a transport vehicle according to the present disclosure.

FIG. 2 is a block diagram representing a work machine control system according to an embodiment of the present disclosure.

FIG. 3 is a block diagram representing a transport vehicle control system according to an embodiment of the present disclosure.

FIG. 4 is a graphical diagram representing a conventional work cycle including a plurality of transport vehicles.

FIG. 5 is a graphical diagram representing an exemplary work cycle in accordance with embodiments of a system and method of the present disclosure.

FIG. 6 is a flowchart representing an exemplary method according to an embodiment of the present disclosure.

### DETAILED DESCRIPTION

With reference herein to the representative figures, various embodiments may now be described of an inventive system and method.

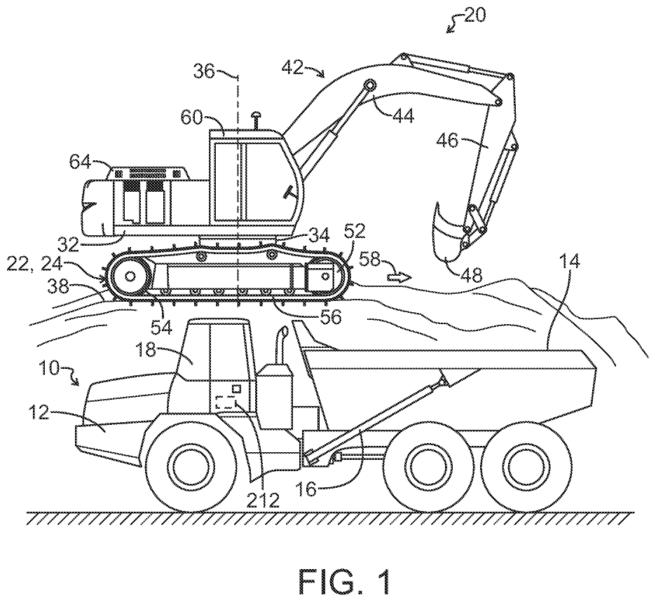

FIG. 1 in a particular embodiment as disclosed herein shows a representative work machine 20 in the form of, for example, a tracked excavator machine, alongside a representative transport vehicle 10 in the form of, for example, an articulated dump truck (ADT).

The work machine 20 includes an undercarriage 22 with first and second ground engaging units 24 driven by first and second travel motors (not shown), respectively. A main frame 32 is supported from the undercarriage 22 by a swing bearing 34 such that the main frame 32 is pivotable about a pivot axis 36 relative to the undercarriage 22. The pivot axis 36 is substantially vertical when a ground surface 38 engaged by the ground engaging units 24 is substantially horizontal. A swing motor (not shown) is configured to pivot the main frame 32 on the swing bearing 34 about the pivot axis 36 relative to the undercarriage 22.

A work implement 42 in the context of the referenced work machine 20 includes a boom assembly 42 with a boom 44, an arm 46 pivotally connected to the boom 44, and a working tool 48. The term “implement” may be used herein to describe the boom assembly (or equivalent thereof) collectively, or individual elements of the boom assembly or equivalent thereof. The boom 44 is pivotally attached to the main frame 32 to pivot about a generally horizontal axis relative to the main frame 32. The working tool in this embodiment is an excavator shovel (or bucket) 48 which is pivotally connected to the arm 46. The boom assembly 42 extends from the main frame 32 along a working direction of the boom assembly 42. The working direction can also be described as a working direction of the boom 44. As described herein, control of the work implement 42 may relate to control of any one or more of the associated components (e.g., boom 44, arm 46, tool 48).

It is within the scope of the present disclosure that the work machine 20 may take various alternative forms and further utilize alternative work implements 42 to modify the proximate terrain.

In the embodiment of FIG. 1, the first and second ground engaging units 24 are tracked ground engaging units, although various alternative embodiments of a work machine 20 are contemplated wherein the ground engaging units 24 may be wheeled ground engaging units. Each of the tracked ground engaging units 24 as represented includes an idler 52, a drive sprocket 54, and a track chain 56 extending around the idler 52 and the drive sprocket 54. The travel motor of each tracked ground engaging unit 24 drives its respective drive sprocket 54. Each tracked ground engaging unit 24 is represented as having a forward traveling direction 58 defined from the drive sprocket 54 toward the idler 52. The forward traveling direction 58 of the tracked ground engaging units 24 also defines a forward traveling direction 58 of the undercarriage 22 and thus of the work machine 20. In some applications, including uphill travel as further discussed below, the orientation of the undercarriage 22 may be reversed such that a traveling direction of the work machine 20 is defined from the idler 52 toward its respective drive sprocket 54, whereas the work implement(s) 42 is still positioned ahead of the undercarriage 22 in the traveling direction.

Although an excavator as the work machine 20 may be self-propelled in accordance with the above-referenced elements, other forms of work machines 20 may be contemplated within the scope of the present disclosure that are not self-propelled, unless otherwise specifically noted.

An operator's cab 60 may be located on the main frame 32. The operator's cab 60 and the boom assembly 42 may both be mounted on the main frame 32 so that the operator's cab 60 faces in the working direction 58 of the boom assembly. A control station (not shown) may be located in the operator's cab 60. The control station may include or otherwise be associated with a user interface as further described below, but it should be understood that a control station and/or user interface within the scope of the present disclosure may be disposed locally, remotely, or otherwise distributed in the context of an autonomous embodiment and corresponding operation. As used herein, directions with regard to work machine 20 may be referred to from the perspective of an operator seated within the operator cab 60; the left of the work machine is to the left of such an operator, the right of the work machine is to the right of such an operator, a front-end portion (or fore) of the work machine is the direction such an operator faces, a rear-end portion (or aft) of the work machine is behind such an operator, a top of the work machine is above such an operator, and a bottom of the work machine below such an operator.

Also mounted on the main frame 32 is an engine 64 for powering the work machine 20. The engine 64 may be a diesel internal combustion engine. The engine 64 may drive a hydraulic pump to provide hydraulic power to the various operating systems of the work machine 20.

An articulated dump truck 10 as representing a transport vehicle 10 in FIG. 1 may include a plurality of wheels and associated axles, and a frame 12 supporting a loading container 14 (e.g., truck bed) having for example a loading surface at the bottom of an interior area surrounded by sidewalls. A hydraulic piston-cylinder unit 16 may be coupled between the frame 12 and the loading container 14 and configured to selectively extend and raise/pivot the loading container 14 rearward to a dumping position, and to retract and lower/pivot the loading container forward from the dumping position to a travel and loading position (as shown). An operator's cab 18 of the transport vehicle 10 may be located on the frame 12, wherein directions with regard to the transport vehicle 10 may be referred to from the perspective of an operator seated within the operator cab 18 (in for example non-autonomous embodiments where such an operator is actually seated therein); the left of the transport vehicle is to the left of such an operator, the right of the transport vehicle is to the right of such an operator, a front-end portion (or fore) of the transport vehicle is the direction such an operator faces, a rear-end portion (or aft) of the transport vehicle is behind such an operator, a top of the transport vehicle is above such an operator, and a bottom of the transport vehicle below such an operator.

A controller 212 for the truck 10 may in some embodiments comprise or otherwise be associated with an operator interface in the operator's cab 18, as further described below.

As represented in FIG. 1, the work machine 20 is in an elevated position relative to the transport vehicle 10, but it may be appreciated that in various loading applications the work machine 20 and the transport vehicle 10 may be at substantially the same level and/or at various respective orientations relative to each other.

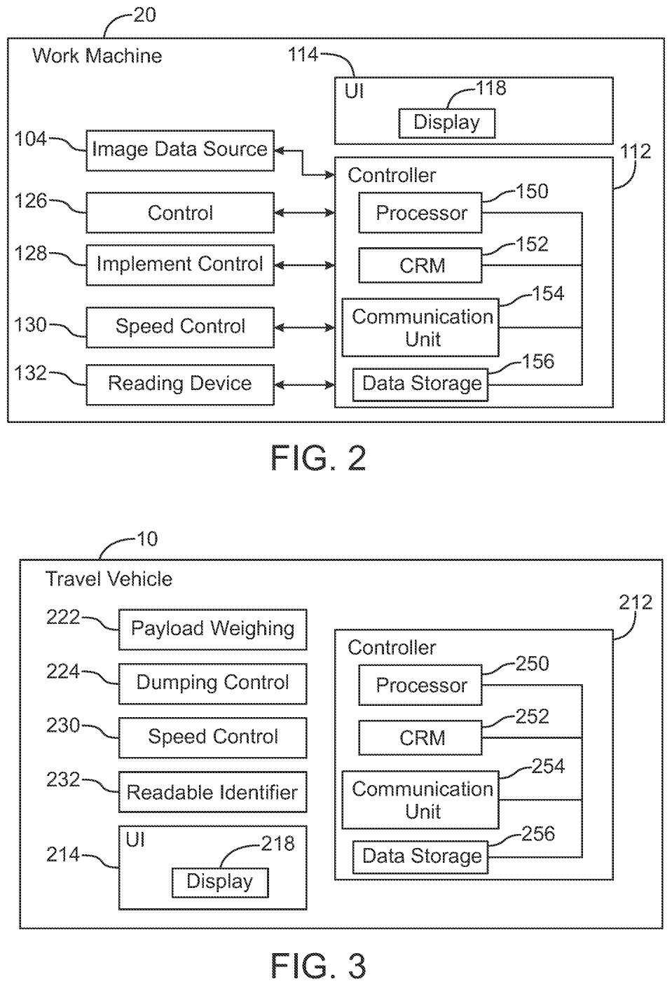

As schematically illustrated in FIG. 2, the work machine 20 may include a control system including a controller 112. The controller 112 may be part of the machine control system of the work machine 20, or it may be a separate control module.

The controller 112 is configured to receive input signals from some or all of various image data sources 104 such as cameras and collectively defining an imaging system. The image data sources 104 may be mounted on the main frame 32 of the work machine 20 and arranged to capture images or otherwise generate image data corresponding to surroundings of the work machine 20. The image data sources 104 may include video cameras configured to record an original image stream and transmit corresponding data to the controller 112. In the alternative or in addition, the image data sources 104 may include one or more of an infrared camera, a stereoscopic camera, a PMD camera, or the like. One of skill in the art may appreciate that high resolution light detection and ranging (LiDAR) scanners, radar detectors, laser scanners, and the like may be implemented as image data sources within the scope of the present disclosure. The number and orientation of said image data sources 104 may vary in accordance with the type of work vehicle 20 and relevant applications, but may at least be provided with respect to an area in a travelling direction of the work vehicle 20 and configured to capture image data associated with a loading area 14 proximate the work vehicle 20. Alternative implementations within the scope of the present disclosure could use simpler near field radio communications to designate proximity, global positioning system (GPS) location signals, and the like.

The position and size of an image region recorded by a respective camera 104 as an image data source may depend on the arrangement and orientation of the camera and the camera lens system, in particular the focal length of the lens of the camera, but may desirably be configured to capture substantially the entire loading area 16 throughout a loading operation. One of skill in the art may further appreciate that image data processing functions may be performed discretely at a given image data source if properly configured, but also or otherwise may generally include at least some image data processing by the controller or other downstream data processor. For example, image data from any one or more image data sources may be provided for three-dimensional point cloud generation, image segmentation, object delineation and classification, and the like, using image data processing tools as are known in the art in combination with the objectives disclosed.

The controller 112 of the work machine 20 may be configured to produce outputs, as further described below, to a user interface 114 associated with a display unit 118 for display to the human operator. The controller 112 may be configured to receive inputs from the user interface 114, such as user input provided via the user interface 114. Not specifically represented in FIG. 2, the controller 112 of the work machine 20 may in some embodiments further receive inputs from and generate outputs to remote devices associated with a user via a respective user interface, for example a display unit with touchscreen interface. Data transmission between for example the vehicle control system and a remote user interface may take the form of a wireless communications system and associated components as are conventionally known in the art. In certain embodiments, a remote user interface and vehicle control systems for respective work machines 20 may be further coordinated or otherwise interact with a remote server or other computing device for the performance of operations in a system as disclosed herein.

The controller 112 may in various embodiments be configured to generate control signals for controlling the operation of respective actuators, or signals for indirect control via intermediate control units, associated with a machine steering control system 126, a machine implement control system 128, and an engine speed control system 130. The control systems 126, 128, 130 may be independent or otherwise integrated together or as part of a machine control unit in various manners as known in the art. The controller 112 may for example generate control signals for controlling the operation of various actuators, such as hydraulic motors or hydraulic piston-cylinder units (not shown), and electronic control signals from the controller 112 may actually be received by electro-hydraulic control valves associated with the actuators such that the electro-hydraulic control valves will control the flow of hydraulic fluid to and from the respective hydraulic actuators to control the actuation thereof in response to the control signal from the controller 112.

A reading device 132 as conventionally known in the art such as for example an RFID device, barcode scanner, or the like may further be provided and communicatively linked to the controller 112 for obtaining readable information associated with a particular transport vehicle 10.

The controller 112 includes or may be associated with a processor 150, a computer readable medium 152, a communication unit 154, and data storage 156 such as for example a database network. It is understood that the controller 112 described herein may be a single controller having some or all of the described functionality, or it may include multiple controllers wherein some or all of the described functionality is distributed among the multiple controllers.

Various operations, steps or algorithms as described in connection with the controller 112 can be embodied directly in hardware, in a computer program product such as a software module executed by the processor 150, or in a combination of the two. The computer program product can reside in RAM memory, flash memory, ROM memory, EPROM memory, EEPROM memory, registers, hard disk, a removable disk, or any other form of computer-readable medium 152 known in the art. An exemplary computer-readable medium 152 can be coupled to the processor 150 such that the processor 150 can read information from, and write information to, the memory/storage medium 152. In the alternative, the medium 152 can be integral to the processor 150. The processor 150 and the medium 152 can reside in an application specific integrated circuit (ASIC). The ASIC can reside in a user terminal. In the alternative, the processor 150 and the medium 152 can reside as discrete components in a user terminal.

The term “processor” 150 as used herein may refer to at least general-purpose or specific-purpose processing devices and/or logic as may be understood by one of skill in the art, including but not limited to a microprocessor, a microcontroller, a state machine, and the like. A processor 150 can also be implemented as a combination of computing devices, e.g., a combination of a DSP and a microprocessor, a plurality of microprocessors, one or more microprocessors in conjunction with a DSP core, or any other such configuration.

The communication unit 154 may support or provide communications between the controller 112 and external communications units, systems, or devices, and/or support or provide communication interface with respect to internal components of the work machine 20. The communications unit may include wireless communication system components (e.g., via cellular modem, WiFi, Bluetooth or the like) and/or may include one or more wired communications terminals such as universal serial bus ports.

The data storage 156 as further described below may, unless otherwise stated, generally encompass hardware such as volatile or non-volatile storage devices, drives, electronic memory, and optical or other storage media, as well as in certain embodiments one or more databases residing thereon.

As schematically illustrated in FIG. 3, in embodiments of a system as disclosed herein the plurality of transport vehicles 10 may each include a respective control system including a controller 212. The controller 212 may be part of a vehicle control system of the transport vehicle 10, or it may be a separate control module.

The controller 212 of a respective transport vehicle 10 may be configured to receive input signals from a payload weighing unit 322 as is conventionally known in the art for certain articulated dump trucks. The controller 212 may further integrate or otherwise communicate with a dumping control system 324 to selectively direct the operation of the hydraulic piston-cylinder unit 16 for articulating the loading container 14 between a loading position and a dumping position. The travel vehicle 10 may further comprise a barcode 332 or otherwise generate another form of machine-readable identifier 332 such as for example an RFID signal via a transceiver or the like for communicating readable information to a work machine 20 or the like. Alternative implementations within the scope of the present disclosure, and as alluded to above with respect to optional data sources associated with the work machine, could use near field radio communications, GPS location signals, and/or the like to generate signals corresponding to a relative proximity there between.

In certain embodiments, the controller 212 may further integrate or otherwise communicate with an image data sources (not shown) such as vehicle-mounted cameras or the like.

The controller 212 of a respective transport vehicle 10 may be configured to produce outputs, as further described below, to a user interface 214 associated with a display unit 218 for display to the human operator. The controller 212 may be configured to receive inputs from the user interface 214, such as user input provided via the user interface 214.

The controller 212 of a respective transport vehicle 10 may further include or be associated with a processor 250, a computer readable medium 252, a communication unit 254, and data storage 256 such as for example a database network. It is understood that the controller 212 described herein may be a single controller having some or all of the described functionality, or it may include multiple controllers wherein some or all of the described functionality is distributed among the multiple controllers.

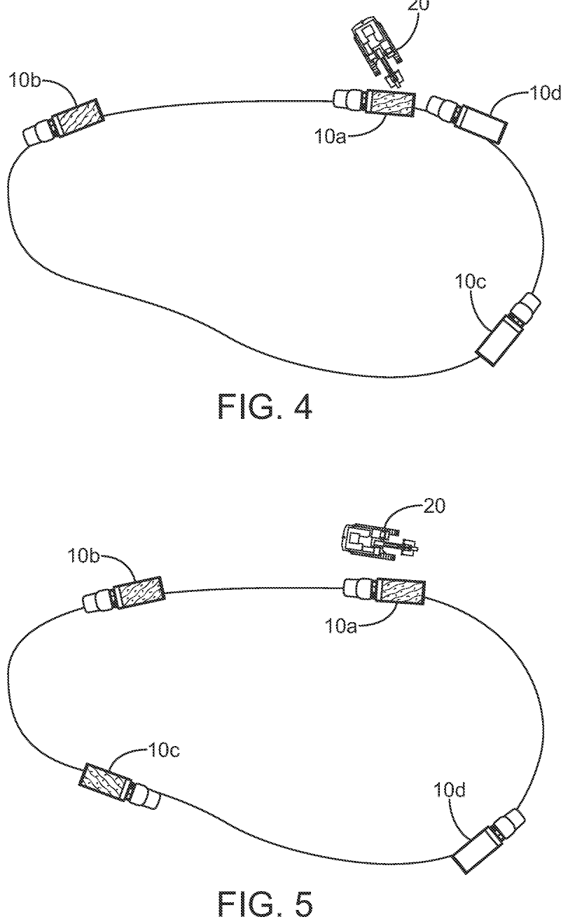

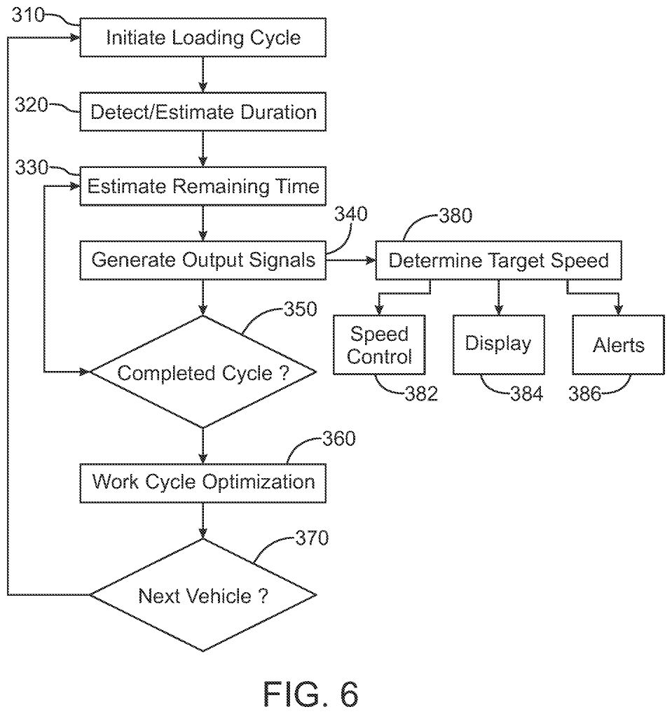

Referring next to FIG. 6, with further illustrative reference to FIGS. 4 and 5, an embodiment of a method 300 may now be described which is exemplary but not limiting on the scope the present disclosure unless otherwise specifically noted. One of skill in the art may appreciate that alternative embodiments may include fewer or additional steps, and that certain disclosed steps may for example be performed in different chronological order or simultaneously.

As previously noted, the method 300 may address a conventional lack of adequate communication and synchronization between transport vehicles in a work (e.g., load-dump) cycle. As represented in FIG. 4, a plurality of trucks 10a, 10b, 10c, 10d may be tasked with sequentially receiving loads of material from or in association with a work machine 20, wherein for example transport vehicle 10d must await completion of the loading cycle for preceding transport vehicle 10a in the work cycle. As shown, transport vehicle 10d has advanced more quickly than was necessary and must now idle in wait while the loading cycle for transport 10a is completed. The unnecessarily rapid advance and repeated start/stop process leads to the burning of more fuel than would otherwise be required, also potentially to wear and tear on the drivetrain that may be avoided using a method 300 of the present disclosure.

Referring next to FIG. 5, the disclosed method 300 and equivalents thereof may desirably provide improved flow synchronization among the plurality of transport vehicles 10a, 10b, 10c, 10d such that spacing is evened out, the vehicles can maintain a more appropriate (i.e., consistent and/or reduced) travel speed through the work cycle, and there is little to no required idle time while awaiting the preceding vehicle during its respective loading cycle. Briefly stated, as the preceding transport vehicle 10b is leaving a loading area proximate the work machine 20, a new transport vehicle 10a can theoretically pull into the loading area immediately thereafter.

In various embodiments, the method 300 may further enable matching of a number of the plurality of transport vehicles 10 to a determined work machine capacity 10, based in part on the time required for a loading cycle and further on the type required to transport the loaded material, dump the loaded material, and return for initiation of another loading cycle.

As shown in FIG. 6, an embodiment of the method 300 may begin with the initiating of a loading cycle (step 310) for a wok machine 20 and a respective transport vehicle 10. The method 300 may accordingly be described as repeating for each of a plurality of transport vehicles 10 and is by no means limited for example to the first transport vehicle in a work cycle. The loading cycle for a given work machine/transport vehicle combination may be substantially performed in a manner as conventionally known.

In the present embodiment, the method 300 may continue by detecting and/or estimating a duration for the loading cycle associated with the present transport vehicle 10, for example transport vehicle 10a as shown in FIG. 5 (step 320), and estimating a remaining time in the loading cycle based at least in part thereon (step 330).

For example, an amount of time required for a loading cycle associated with a present (or approaching) transport vehicle may depend on loading cycle data comprising one or more of: the type of transport vehicle; a configuration of loading container associated with the transport vehicle; a type of work machine; a type and/or condition of material being loaded; a loading rate; and the like. In some embodiments, the amount of time required for the loading cycle may be for example predetermined with respect to a given transport vehicle, or based on historical information from previous loading cycles for, e.g., the same transport vehicle, the same transport vehicle/work machine combination, an average of previous loading cycles for all transport vehicles or a selected subset of said vehicles similar to the current transport vehicle or otherwise relevant to characteristics thereof, or entered directly by the operator, etc. For example, a learning algorithm may be configured to identify previous loading cycles as being relevant to any one or more conditions or characteristics of a current loading cycle and then predict or estimate the amount of time required for the current loading cycle based at least in part thereon. In various embodiments, the predetermined loading cycle data may serve as a baseline which is optionally altered in view of present conditions or characteristics of the current loading cycle. The work machine may be configured to identify the transport vehicle (e.g., via a machine-readable element on the transport vehicle) and retrieve the predetermined loading cycle data from data storage, or the predetermined loading cycle data may be transmitted from the transport vehicle to the work machine upon (or just prior to) initiation of the loading cycle.

In determining a remaining time in the loading cycle, this may further depend for example on an output from a payload weighing unit for the transport vehicle and/or a volume estimation with respect to loaded material on the transport vehicle. Volume estimation may for example be performed based on a scanned profile of the loaded material. The remaining time may be estimated based on the initially estimated duration for the loading cycle further in view of an elapsed amount of time, further in view of the current payload measurement and/or estimated volume to confirm, correct, or otherwise refine the initial estimation. For example, one or more of the above-referenced conditions may change such that the loading cycle is proceeding more or less rapidly than was initially predicted, which further may be accounted for in the determined remaining time and in subsequent steps of the method 300.

The method 300 continues with the generation of output signals (step 340) from either or both of the work machine controller 112 and/or the transport vehicle controller 212. The output signals may typically correspond to at least the determined remaining time for the current loading cycle. In an embodiment, the output signals may be generated for data transmission from the work machine controller 112 and/or the transport vehicle controller 212 directly to at least a next transport vehicle 10, for example transport vehicle 10d as shown in FIG. 5, in the work cycle.

In another embodiment, output signals may be broadcast from the work machine controller 112 and/or the transport vehicle controller 212 for reception by any of the transport vehicles in the work cycle that are within range.

In another embodiment, output signals may be generated in the form of a message to at least a next transport vehicle in the work cycle, wherein the message is processed by the respective transport vehicle controller and further forwarded to subsequent transport vehicles in the work cycle as defining a network of nodes in a machine-to-machine data transmission network. In such an example, each transport vehicle controller 212 may modify the received message content such that each message to a subsequent transport vehicle controller reflects the position of the transmitting transport vehicle and the aggregate estimated time to completion of the loading cycle for the transmitting transport vehicle, i.e., accounting for each loading cycle prior to the loading cycle for the next transport vehicle in the work cycle queue. Each transport vehicle controller 212 may accordingly be configured to confirm that the message was received from a transport vehicle known to be immediately preceding the respective transport vehicle in the work cycle queue, so as to ensure that the calculations are properly aggregated, and further to include an identifier in the message delivered therefrom for the same reasons with respect to the downstream transport vehicle.

In another embodiment, any of the preceding examples may be further or otherwise implemented via a remote server, wherein output signals from the work machine controller 112 and/or the transport vehicle controller 212 are generated to the server for further processing and/or transmission to other transport vehicles in the work cycle/data network.

In an embodiment as illustrated in FIG. 6, a target speed is determined (step 380) for at least the next transport vehicle 10, for example transport vehicle 10d as shown in FIG. 5. The target speed may be determined remotely and transmitted to the transport vehicle 10d, for example by the work machine controller 112, or may in various embodiments be determined by the controller 212 for the transport vehicle 10d itself. The target speed is set to avoid the above-referenced problem wherein the transport vehicle drives faster than is necessary and arrives too early at the loading site, and preferably may be set in accordance with an expected start of the respective loading cycle, based on at least estimated loading cycle duration(s) for each of the intervening transport vehicles and an estimated remaining time in the loading cycle of the current transport vehicle 10a. In certain embodiments, a target speed may be set using knowledge of previous trips (e.g., via a learning technique) to force a speed at a more efficient operating point for each relevant portion of the transport cycle. The target speed may be determined for at least the next transport vehicle 10 as described above based on at least the estimated remaining time and one or more parameters associated with a route between said transport vehicle and the work machine 20. The “route” may include or otherwise account for a distance to the loading location, known or determined characteristics of the terrain there between, detours or other dynamic alterations for anomalies such as lunch breaks, etc. Distance estimates may for example be performed based on a previous trip by the transport vehicle 10, an average of all trips on a given work site, a distance associated with a last load-dump cycle for all transport vehicles 10, and the like.

In various embodiments, the determination of a target speed may not be explicitly performed, but rather an average speed and/or estimated time to destination (i.e., location of the work machine 20) may be determined as a value to be provided to a driver or controller of the respective transport vehicle 10.

The output signals and/or determined target speed/average speed/estimated time to destination may be provided as inputs for one or more of the following sub-steps.

In an embodiment, an automatic speed control mode (step 382) may be implemented, for example upon operator selection. In this mode, the transport vehicle controller 212 automatically adjusts or otherwise maintains the speed based on the target speed or based on an average speed further in view of the terrain and an available amount of time to destination. The driver may typically still provide the necessary inputs for control over steering and braking of the transport vehicle 10.

In another embodiment, a manual display mode (step 384) may utilize messages on a display unit 218 of the transport vehicle 10 to inform the driver of, e.g., an available time until the estimated loading cycle initiation versus an estimated time of arrival based on the current speed. The display may be dynamically updated to account for changes in speed, changes in conditions in the route between the transport vehicle and the loading area, changes in the estimated loading cycle duration for the current loading cycle, and the like.

In another embodiment, a manual economy mode (step 386) may be utilized to provide alerts to the driver via the user interface or an equivalent thereof, for example informing the driver if the transport vehicle is ahead of or behind an optimal pace for arrival. Such alerts may be visually provided, for example in the form of designated colors of lights corresponding to states such as ahead of time, on time, etc. Such alerts may further or alternatively be audible in nature, or even vibratory, etc.

The output signals may be continuously or periodically generated during the loading cycle, or until the loading cycle is determined to be completed (i.e., “yes” in response to the query in step 350), wherein in some embodiments a work cycle optimization model may be queried and/or updated. Loading cycle data for the just completed loading cycle may be provided to an optimization model for subsequent loading cycle iterations, further in combination with other events associated with a complete work cycle for the respective transport vehicle.

For example, in one embodiment a theoretical minimum and/or maximum duration of a work cycle, or an expected range about a standard work cycle, may be determined (wherein the work cycle comprises the loading cycle and a dumping cycle) for at least one (preferably all) of the plurality of transport vehicles. Based at least in part thereon, a minimum and/or maximum number of transport vehicles to optimize the work cycle may further be determined.

If a current loading cycle is completed and there is still material to be loaded (i.e., “yes” in response to the query in step 370), the method 300 may return to step 310 and repeat for another loading cycle with the next transport vehicle in the queue.

As used herein, the phrase “one or more of,” when used with a list of items, means that different combinations of one or more of the items may be used and only one of each item in the list may be needed. For example, “one or more of” item A, item B, and item C may include, for example, without limitation, item A or item A and item B. This example also may include item A, item B, and item C, or item Band item C.

One of skill in the art may appreciate that when an element herein is referred to as being “coupled” to another element, it can be directly connected to the other element or intervening elements may be present.

Thus, it is seen that the apparatus and methods of the present disclosure readily achieve the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or embodiment may be combined with any of the other disclosed features or embodiments.

What is claimed is:

1. A computer-implemented method of flow synchronization between a plurality of transport vehicles and a work machine in a material loading cycle, wherein the plurality of transport vehicles each comprise a loading container, and wherein at least each of the plurality of transport vehicles are operable for communication with each other via a communications network, the method comprising:
initiating a loading cycle associated with the work machine and a first transport vehicle of the plurality of transport vehicles;
detecting one or more parameters corresponding to a duration of the loading cycle including the first transport vehicle, and based at least in part thereon estimating a remaining time in the duration of the loading cycle including the first transport vehicle;
generating an output signal corresponding to the estimated remaining time to at least a second transport vehicle of the plurality of transport vehicles.

2. The method of claim 1, further comprising determining for the second transport vehicle a target speed based on at least the estimated remaining time and one or more parameters associated with a route between the second transport vehicle and the work machine.

3. The method of claim 2, further comprising automatically controlling a speed of the second transport vehicle corresponding to the target speed.

4. The method of claim 2, further comprising generating a display via a user interface associated with the second transport vehicle, the display comprising one or more of the determined target speed, the estimated remaining time, and the one or more parameters associated with the route between the second transport vehicle and the work machine.

5. The method of claim 4, further comprising generating alerts via the user interface corresponding to a detected actual travel speed being outside of a predetermined tolerance with respect to the target speed.

6. The method of claim 1, comprising, for each of the plurality of transport vehicles other than the first transport vehicle, estimating a remaining time in the duration of the loading cycle including the first transport vehicle and a duration of a loading cycle for each other one of the plurality of transport vehicles between the respective transport vehicle and the work machine, and generating an output signal corresponding to the estimated remaining time to a subsequent transport vehicle in a sequence of the plurality of transport vehicles.

7. The method of claim 1, comprising determining a minimum duration of a work cycle comprising the loading cycle and a dumping cycle for at least one of the plurality of transport vehicles, and determining a minimum and/or maximum number of transport vehicles to optimize the work cycle based thereon.

8. The method of claim 1, comprising determining an available number of transport vehicles and a minimum duration of a work cycle comprising the loading cycle and a dumping cycle for at least one of the plurality of transport vehicles, and dynamically adjusting operation of the work machine to optimize performance based thereon.

9. The method of claim 1, wherein the detected one or more parameters corresponding to a duration of the loading cycle including the first transport vehicle comprises a weighed payload of material at the transport vehicle.

10. The method of claim 1, wherein the detected one or more parameters corresponding to a duration of the loading cycle including the first transport vehicle comprises an estimated volume of the loading area of the first transport vehicle, and wherein the volume is estimated via a scanned image of the loading area via an image data source associated with the work machine.

11. The method of claim 1, wherein the detected one or more parameters corresponding to a duration of the loading cycle including the first transport vehicle comprises an estimated volume of the loading area of the first transport vehicle, and wherein the volume is estimated via an identifier wirelessly read out from the first transport vehicle when in proximity with the work machine, and from information retrievably stored in associated with the identifier.

12. The method of claim 1, wherein the detected one or more parameters corresponding to a duration of the loading cycle including the first transport vehicle comprises one or more previous load times retrieved from data storage.

13. The method of claim 12, wherein the one or more previous load times are associated with the first transport vehicle.

14. The method of claim 12, wherein the one or more previous load times are selected from data storage based at least in part on one or more characteristics of the first transport vehicle.

15. A work machine configured for flow synchronization with a plurality of transport vehicles in a material loading cycle, wherein the plurality of transport vehicles each comprise a loading container, the work machine comprising:
a communications unit configured for communication with each of the plurality of transport vehicles via a wireless communications network; and
a controller configured for
detecting initiation of a loading cycle associated with a first transport vehicle of the plurality of transport vehicles,
detecting one or more parameters corresponding to a duration of the loading cycle including the first transport vehicle, and based at least in part thereon estimating a remaining time in the duration of the loading cycle including the first transport vehicle, and
generating an output signal via the communications unit corresponding to the estimated remaining time to at least a second transport vehicle of the plurality of transport vehicles.

16. The work machine of claim 15, wherein the controller is configured to determine a minimum duration of a work cycle comprising the loading cycle and a dumping cycle for at least one of the plurality of transport vehicles, and determine a minimum and/or maximum number of transport vehicles to optimize the work cycle based thereon.

17. The work machine of claim 15, wherein the controller is configured to determine an available number of transport vehicles and a minimum duration of a work cycle comprising the loading cycle and a dumping cycle for at least one of the plurality of transport vehicles, and dynamically adjust operation of the work machine to optimize performance based thereon.

18. A system for flow synchronization between a plurality of transport vehicles and a work machine in a material loading cycle, wherein the plurality of transport vehicles each comprise a loading area, the system comprising:
for each of the work machine and the plurality of transport vehicles, a communications unit operable for communication with each other of the work machine and the plurality of transport vehicles via a wireless communications network;
a controller associated with the work machine and configured to
detect initiation of a loading cycle associated with the work machine and a first transport vehicle of the plurality of transport vehicles,
detect one or more parameters corresponding to a duration of the loading cycle including the first transport vehicle, and based at least in part thereon estimating a remaining time in the duration of the loading cycle including the first transport vehicle, and
generate an output signal corresponding to the estimated remaining time to at least a second transport vehicle of the plurality of transport vehicles.

19. The system of claim 18, wherein each of the plurality of transport vehicles further comprises a respective controller configured to determine a target speed based on at least the estimated remaining time and one or more parameters associated with a route between the respective transport vehicle and the work machine.

20. The system of claim 19, wherein the respective controller for each transport vehicle is further configured, when it is not in a loading cycle, to estimate a remaining time in the duration of the loading cycle including the first transport vehicle and a duration of a loading cycle for each other one of the plurality of transport vehicles between the respective transport vehicle and the work machine, and generating an output signal corresponding to the estimated remaining time to a subsequent transport vehicle in a sequence of the plurality of transport vehicles.
